(19) United States
(12) Patent Application Publication
(10) Pub. No.: US 2003/0032705 A1
(43) Pub. Date: Feb. 13, 2003

(54) Ethylene terpolymer adhesive for condensing furnace heat exchanger laminate material

(76) Inventor: James William Otter, Fairfield Glade, TN (US)

Correspondence Address: CARLSON, GASKEY & OLDS, P.C., 400 WEST MAPLE ROAD, SUITE 350, BIRMINGHAM, MI, 48009, US

(21) Appl. No.: 09/923,554

(22) Filed: Aug. 7, 2001

(51) Int. Cl. B32B 31/00

(52) U.S. Cl. 524/327; 156/307.1

(57) ABSTRACT

Cured ethylene terpolymer attaches a film to the metal surface of a condensing heat exchanger of a condensing furnace to prevent corrosion of the condensing heat exchanger. After applying a layer of ethylene terpolymer to the metal surface of the condensing heat exchanger, a film is positioned on the layer. Water reacts with the organosilicone functional groups on the ethylene terpolymer chain, cross-linking the organosilicone functional groups and adhering the film to the surface of condensing heat exchanger. The water is provided in the film or is added by an external source. Preferably, the film is polar to encourage adhesion of the water to the film and encourage cross-linking of the organosilicone functional groups.

### BACKGROUND OF THE INVENTION

The present invention relates generally to a cured ethylene terpolymer layer which adheres a film to a condensing heat exchanger without utilizing a primer and adhesive.

Condensing heat exchangers are employed in condensing furnaces to increase efficiency. The condensing heat exchanger cools the heating fluid to a temperature below the dew point. As the temperature drops below the dew point, a liquid condensate, water vapor, condenses from the heating fluid. As the liquid condensate condenses, heat is transferred from the water vapor to the air to be heated. As more heat is produced, the efficiency of the system is increased.

Polypropylene films are commonly utilized to make a laminate for a condensing furnace heat exchanger to prevent corrosion by the water vapor liquid condensate. The present method of making the laminate is expensive. A primer is first applied to the pretreated steel of the condensing heat exchanger. After a bake cycle, an adhesive is applied, following again by a bake cycle. The polypropylene film is then thermally laminated to the adhesive, attaching the film to the metal surface of the condensing heat exchanger.

There are several drawbacks to utilizing the primer and adhesive of the prior art. For one, both the primer and the adhesive contain high percentages of expensive solvents which must be combusted to meet “clean air” regulations. Additionally, the formulation of the primer is occasionally changed by the manufacturer, resulting in production problems and failed inspections.

Hence, there is a need in the art for a layer which adheres a film to a condensing heat exchanger without utilizing a primer and adhesive.

### SUMMARY OF THE INVENTION

The present invention relates to a cured ethylene terpolymer layer which adheres a film to a condensing heat exchanger without utilizing a primer and adhesive.

A film is attached to the metal plate of a condensing heat exchanger of a condensing furnace by a layer of cured ethylene terpolymer to prevent corrosion of the condensing heat exchanger. The layer of ethylene terpolymer is coated on the surface of the metal plate of the condensing heat exchanger by a roller. The ethylene terpolymer is a chain of three different ethylene constituents with an organosilicone functional group on the end of the chain which cross-links with the aid of water.

The film is then layered over the ethylene terpolymer layer. The addition of water to the layer of ethylene terpolymer cures the ethylene terpolymer and adheres the film to the surface of the metal plate. Water cross-links the organosilicone functional groups on the ethylene terpolymer, creating an adhesive surface which secures the film to the metal sheet. The water is contained in the film or is supplied by an external source. If the water is applied by an external source, the water is applied to the metal plate prior to applying the layer of ethylene terpolymer, applied on the film after application to the metal plate, or is added by steam which permeates the film. Preferably, the film is polar to encourage adhesion of the water to the film.

Accordingly, the present invention provides an ethylene terpolymer layer which adheres a film to a condensing heat exchanger without utilizing a primer and adhesive.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawing that accompany the detailed description can be briefly described as follows:

FIG. 1 illustrates a schematic diagram of a condensing furnace system;

FIG. 2 illustrates a schematic diagram of a pair of cells of a condensing heat exchanger; and

FIG. 3 illustrates a side view of a metal plate of a condensing heat exchanger with a layer of ethylene terpolymer;

FIG. 4 illustrates a side view of a metal plate of a condensing heat exchanger with a film applied on the layer of ethylene terpolymer;

FIG. 5 illustrates a side view of a metal plate of a condensing heat exchanger with a polar surface applied on the film.

### DETAILED DESCRIPTION OF THE PREFERRED EMBODIMENT

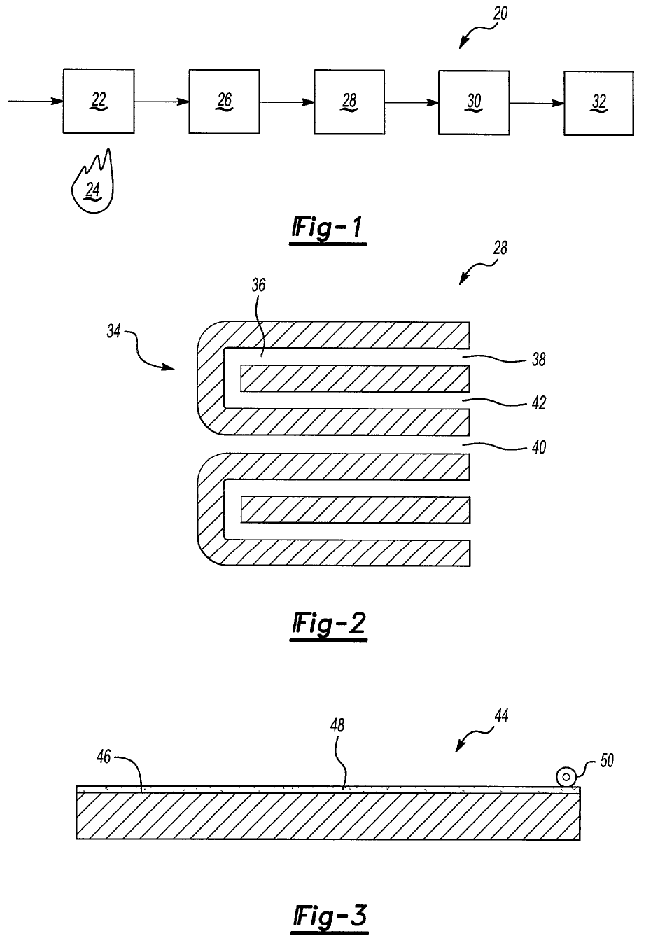

FIG. 1 schematically illustrates a condensing furnace system 20. Air and natural gas enters a burner 22 which burns the air and natural gas by a flame 24 to produce hot combustion products. The hot combustion products pass through a primary heat exchanger 26, which cools the hot combustion products and extracts heat to the air to be heated. To increase the efficiency of the system 20, a condensing heat exchanger 28 is used to extract additional heat. As the hot combustion gases pass through the condensing heat exchanger 28, the condensing heat exchanger 28 cools the combustion products to a temperature below the dewpoint of the combustion products. Water vapor begins to condense, allowing more heat to be extracted from the combustion products and increasing efficiency. As the liquid condensate condenses, heat is transferred from the water vapor to the air to be heated. An inducer fan 30 provides a source of suction on the condensing heat exchanger 28 and assists in pulling the flow of the combustion products through the system 20. The combustion products are expelled from the system 20 through a flue 32.

FIG. 2 illustrates a pair of cells 34 of the condensing heat exchanger 28. Each cell 34 including a flow passage 36 through which the combustion products or flue gases flow. The hot flue gases enter the flow passage 36 through an inlet 38. As the hot flue gases flow through the flow passage 36, heat is transferred to the air to be heated which flows in the air passage 40 between the cells 34. The cooled flue gases then exit the cell 34 through the outlet 42. Although only two cells 34 are illustrated, a plurality of cells are employed in the condensing heat exchanger 28.

A schematic view of the metal plate 44 used to form the condensing heat exchanger 28 is illustrated in FIG. 3. The surface 46 of the metal plate 44 is coated with a layer of ethylene terpolymer 48. Preferably, the layer of ethylene terpolymer 48 is between 0.5 to 5 mils. Most preferably, the layer 48 is 1 to 3 mils in thickness. Ethylene terpolymer is commercially available from the EI DuPont of Wilmington, Del.

Ethylene terpolymer includes a chain of three different ethylene constituents with an organosilicone functional group on the end of the chain. Preferably, the layer of ethylene terpolymer 48 is applied by a roller 50. However, other methods of application are possible, and one skilled in the art would understand how to apply the layer of ethylene terpolymer 48.

A film 52 is layered on the ethylene terpolymer layer 48, as shown in FIG. 4. Preferably, the film 52 is polypropylene. The film 52 is adhered to the surface 46 of the metal sheet 30 by curing the layer of ethylene terpolymer 32 with water 54. Water 54 reacts with the organosilicone functional groups on the ethylene terpolymer chain, cross-linking the organosilicone functional groups to create an adhesive surface which adheres the film 52 to the surface 46. Any organosilicone functional group which cross-links with the aid of water can be used. The cross-linking reaction regenerates water.

Preferably, the water 54 which cures the ethylene terpolymer layer 48 is contained in the film 52. The water permeates through the film 52 and reacts with the layer of ethylene terpolymer 48, cross-linking the organosilicone functional groups. Alternatively, the water 54 is applied to the surface 46 of the metal sheet 44 prior to the application of the layer of ethylene terpolymer 48. The water can also be applied to the upper surface 56 of the film 52 after application over the layer of ethylene terpolymer 48. The water 54 permeates through the film 52 and cross-links the organosilicone functional groups. Alternatively, the water 54 is supplied by steam which permeates the film 52.

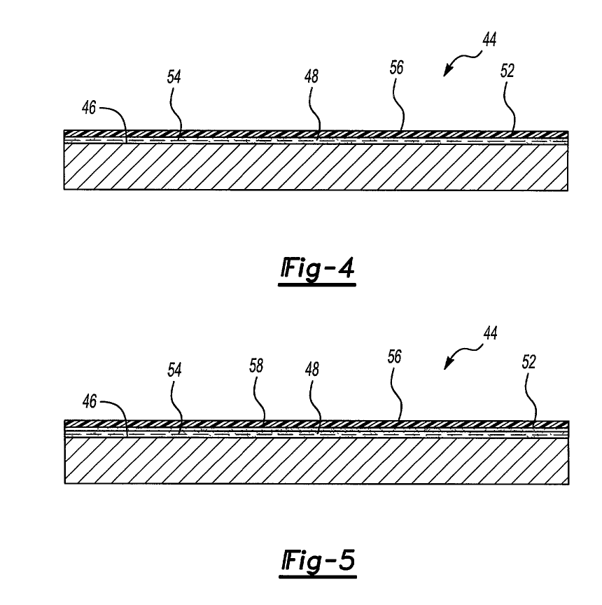

Preferably, as shown in FIG. 5, the film 52 is polar to further encourage adhesion of the water 54 to the film 52 to encourage cross-linking of the organosilicone functional group. A polar surface 58 is created by employing a polar polymer compound with an attached silica or alumina or a non-polar polymer with an attached polar grouping on the film 52. The polarity of the film 52 encourages adhesion of the water 54 to the film 52, encouraging the cross-linking of the organosilicone functional groups and encouraging adhesion of the film 52 to the surface 46 of the metal sheet 44.

There are several advantages to employing the ethylene terpolymer layer 48 of the present invention to attach a film 52 to the surface 46 of a metal plate 44 of a condensing heat exchanger 28 to prevent corrosion of the condensing heat exchanger 28. For one, as a primer is not used, there is a reduction to the release of volatile organic compounds from solvents during the manufacturing process. Films 52 can adhere to the condensing heat exchanger 28 which are difficult to adhere by adhesives or direct thermal lamination. The ethylene terpolymer layer 48 has high thermal resistance to flue gases and to the acidic condensate formed in the condensing heat exchanger 28. Ethylene terpolymer layer 48 cures at a relatively low temperature, and curing is accelerated at higher temperatures. Additionally, as the ethylene terpolymer layer 48 has a high shear valve at high temperatures, such as 190° C., films 52 other than polypropylene which are used at higher temperatures can be utilized.

Accordingly, the present invention provides a cured ethylene terpolymer layer which adheres a film to a condensing heat exchanger without utilizing a primer and adhesive.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specially described. For that reason the following claims should be studied to determine the true scope and content of this invention.

What is claimed is:

1. A method for adhering a film to a heat transfer component comprising the steps of:
applying a layer of ethylene terpolymer including an organosilicone functional group to said heat transfer component;
applying said film to said layer of ethylene terpolymer; and
curing said layer of ethylene terpolymer to adhere said film to said heat transfer component.

2. The method as recited in claim 1 wherein the step of applying said layer of ethylene terpolymer includes application by a roller.

3. The method as recited in claim 1 wherein said film is polypropylene.

4. The method as recited in claim 3 wherein the step of curing said layer of ethylene terpolymer includes adding water to said layer of ethylene terpolymer to cross-link said organosilicone functional groups.

5. The method as recited in claim 4 wherein said water is contained in said film.

6. The method as recited in claim 4 wherein said water is applied to said heat transfer component.

7. The method as recited in claim 4 wherein said water is applied to said film.

8. The method as recited in claim 1 wherein said film is polar to encourage adhesion of said water to and said film to encourage adhesion between said film and said heat transfer component.

9. The method as recited in claim 1 wherein said heat transfer component is a condensing heat exchanger.

10. A heat transfer component of a condensing furnace system comprising:
a metal surface;
a film adhered to said metal surface; and
a cured layer of ethylene terpolymer including an organosilicone functional group to adhere said film to said metal surface.

11. The heat transfer component as recited in claim 10 wherein said layer of ethylene terpolymer is cured by water to cross-links said organosilicone functional groups.
